(19) United States
(12) Patent Application Publication
(10) Pub. No.: US 2013/0093904 A1
(43) Pub. Date: Apr. 18, 2013

(54) Remote Shutter for a Camera or Other Imaging Device

(71) Applicants: Paul F. Wagner, Houston, TX (US); John P. Lines, Houston, TX (US)

(72) Inventors: Paul F. Wagner, Houston, TX (US); John P. Lines, Houston, TX (US)

(73) Assignee: COLE & ASHCROFT LP, Houston, TX (US)

(21) Appl. No.: 13/370,545

(22) Filed: Feb. 10, 2012

Related U.S. Application Data
(60) Provisional application No. 61/441,898, filed on Feb. 11, 2011.

(51) Int. Cl. H04N 5/232

(52) U.S. Cl. CPC H04N 5/232
USPC 348/207.11

(57) ABSTRACT

Described is a system, computer readable medium, and multifunctional device for remotely triggering a visual recording device. The system can include a computer, a mobile device including a camera, and a multifunctional device that can remotely trigger the camera through a first wireless connection. The system's mobile device can further include a computer readable medium for storing an application configured to operate the camera through an Application Programming Interface. The application can further execute instructions for receiving an input from a multifunctional device and remotely triggering a camera coupled to the mobile device based on the input received from the multifunctional device through the first connection. The multifunctional device and the computer can further be adapted to transmit and receive images and videos automatically based on users' preferences. Furthermore, the multifunctional device can include a data interface and a rechargeable power source that can be recharged through the data interface.

### CROSS REFERENCE TO RELATED APPLICATIONS

This application claims priority to U.S. Provisional patent application Ser. No. 61/441,898, filed Feb. 11, 2011, incorporated herein by reference in its entirety.

### STATEMENT REGARDING FEDERALLY SPONSORED RESEARCH OR DEVELOPMENT

Not applicable.

### REFERENCE TO APPENDIX

Not applicable.

### BACKGROUND OF THE INVENTION

1. Field of the Invention

The inventions disclosed and taught herein relate generally to cameras; and more specifically relate to smartphones with camera functions.

2. Description of the Related Art

There are wireless remotes for dedicated cameras. In some cases, there are smart phone applications that allow the smart phone to act as a wireless remote for a dedicated camera.

The inventions disclosed and taught herein are directed to an improved system for remotely operating the camera function of a smartphone, or other multifunctional imaging device.

### BRIEF SUMMARY OF THE INVENTION

Described is a system, computer readable medium, and multifunctional device for remotely triggering a visual recording device. The system can include a computer, a mobile device including a camera, and a multifunctional device that can remotely trigger the camera through a first wireless connection. The system's mobile device can further include a computer readable medium for storing an application configured to operate the camera through an Application Programming Interface. The application can further execute instructions for receiving an input from a multifunctional device and remotely triggering a camera coupled to the mobile device based on the input received from the multifunctional device through the first connection. The multifunctional device and the computer can further be adapted to transmit and receive images and videos automatically based on users' preferences. Furthermore, the multifunctional device can include a data interface and a rechargeable power source that can be recharged through the data interface.

The disclosure also provides a system for remotely triggering a visual recording device that can include a mobile device including a camera and a multifunctional device including a user interface. The multifunctional device can be adapted to remotely trigger the camera through a first connection that can include a wireless connection.

The system can further include a computer adapted to receive data based on a user's preferences stored on the mobile device including a preference to automatically receive the data. These data can include images, videos, or both from the multifunctional device through a second connection. The system can include a computer readable medium adapted to store an application configured to operate the camera through an Application Programming Interface (API) of the mobile device.

The disclosure further provides a computer readable storage medium configured to store an application on a mobile device for remotely triggering a visual recording device. The application can be adapted to execute instructions that includes receiving an input from a multifunctional device including a user interface and remotely triggering a camera coupled to the mobile device based on the input received from the multifunctional device through a first connection that can include a wireless connection.

The remote triggering of a camera can further include operating the camera through an Application Programming Interface (API) of the mobile device. The multifunctional device can include a smartphone. Furthermore, the application can be adapted to further execute instructions for transmitting images, videos, or both from the mobile device to the multifunctional device and receive a user's preferences for transmitting images, videos, or both to the multifunctional device automatically.

The disclosure also provides a multifunctional device for remotely triggering a visual recording device. The multifunctional device can include a user interface that can be adapted to instantiate a remote triggering of a camera coupled to a mobile device and a transceiver that can be adapted to communicate with the mobile device through a first connection that can include a wireless connection. The user interface can be adapted to cause an application stored on the mobile device to trigger the camera through an Application Programming Interface (API) of the mobile device.

The multifunctional device can further include a memory that can be adapted to store images, videos, or both received from the mobile device, a rechargeable power source, and a data interface. The data interface can be adapted to couple with a computer to transmit and receive data, receive power to recharge the rechargeable power source, or both.

### BRIEF DESCRIPTION OF THE SEVERAL VIEWS OF THE DRAWINGS

The following figures form part of the present specification and are included to further demonstrate certain aspects of the present invention. The invention may be better understood by reference to one or more of these figures in combination with the detailed description of specific embodiments presented herein.

FIG. 1 illustrates a block diagram of a particular embodiment of a system utilizing certain aspects of the present inventions.

FIG. 2A illustrates a front view of a first embodiment of the mobile device illustrated in FIG. 1.

FIG. 2B illustrates a back view of the first embodiment of the mobile device illustrated in FIG. 1.

While the inventions disclosed herein are susceptible to various modifications and alternative forms, only a few specific embodiments have been shown by way of example in the drawings and are described in detail below. The figures and detailed descriptions of these specific embodiments are not intended to limit the breadth or scope of the inventive concepts or the appended claims in any manner. Rather, the figures and detailed written descriptions are provided to illustrate the inventive concepts to a person of ordinary skill in the art and to enable such person to make and use the inventive concepts.

### DETAILED DESCRIPTION OF THE INVENTION

Described is a system, computer readable medium, and multifunctional device for remotely triggering a visual recording device. The system can include a computer, a mobile device including a camera, and a multifunctional device that can remotely trigger the camera through a first wireless connection. The system's mobile device can further include a computer readable medium for storing an application configured to operate the camera through an Application Programming Interface. The application can further execute instructions for receiving an input from a multifunctional device and remotely triggering a camera coupled to the mobile device based on the input received from the multifunctional device through the first connection. The multifunctional device and the computer can further be adapted to transmit and receive images and videos automatically based on users' preferences. Furthermore, the multifunctional device can include a data interface and a rechargeable power source that can be recharged through the data interface.

The Figures described above and the written description of specific structures and functions below are not presented to limit the scope of what Applicants have invented or the scope of the appended claims. Rather, the Figures and written description are provided to teach any person skilled in the art to make and use the is inventions for which patent protection is sought. Those skilled in the art will appreciate that not all features of a commercial embodiment of the inventions are described or shown for the sake of clarity and understanding. Persons of skill in this art will also appreciate that the development of an actual commercial embodiment incorporating aspects of the present inventions will require numerous implementation-specific decisions to achieve the developer's ultimate goal for the commercial embodiment. Such implementation-specific decisions may include, and likely are not limited to, compliance with system-related, business-related, government-related, and other constraints, which may vary by specific implementation, location and from time to time. While a developer's efforts might be complex and time-consuming in an absolute sense, such efforts would be, nevertheless, a routine undertaking for those of skill in this art having benefit of this disclosure. It must be understood that the inventions disclosed and taught herein are susceptible to numerous and various modifications and alternative forms. Lastly, the use of a singular term, such as, but not limited to, “a,” is not intended as limiting of the number of items. Also, the use of relational terms, such as, but not limited to, “top,” “bottom,” “left,” “right,” “upper,” “lower,” “down,” “up,” “side,” and the like are used in the written description for clarity in specific reference to the Figures and are not intended to limit the scope of the invention or the appended claims.

Applicants have created a system for remotely triggering a camera of a smartphone comprising an application to be installed on the smartphone and configured to thereafter cause the camera to take a photo, as well as a multifunctional device configured to wirelessly communicate with the smartphone and trigger the application to cause the camera to take the photo. The device may communicate with the smartphone through Bluetooth. The device may be configured to communicate with a computer through a physical connection. The device may be configured to store data and/or exchange the data with the smartphone through the wireless communications and/or a physical connection. The device may also be configured to receive energy through a physical connection, store that energy, and/or charge the smartphone with the sorted energy.

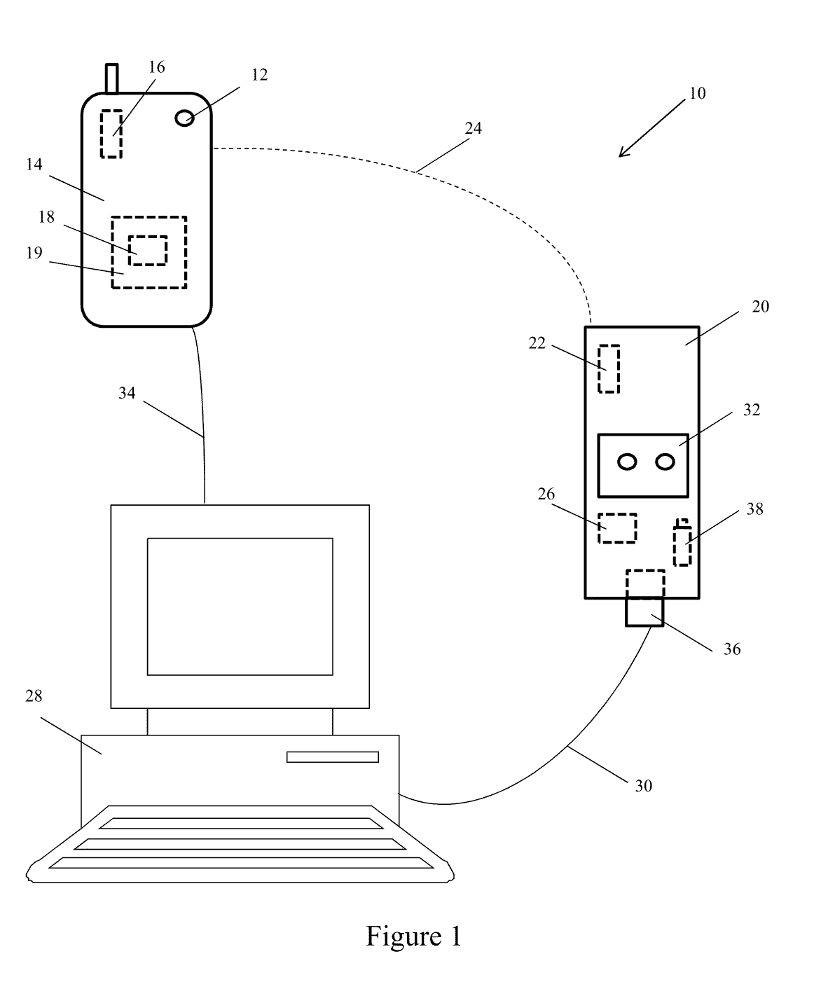

Turning now to the figures, FIG. 1 is an illustration of an exemplary system 10 for remotely triggering a first camera 12 of a smartphone 14 in accordance with the present disclosure. The smartphone 14 is preferably similar to the currently available, iPhone®, one of the smartphones running the ANDROID® operating system, or some future version, or replacement, thereof. Alternatively, in some embodiments, the smartphone may be replaced by some other, equivalent multifunctional imaging device, or other mobile device. For example, the smartphone 14 can be replaced with a mobile device that can include any cellular phone, such as a BlackBerry® device, iPhone®, ANDROID® or any other portable device such as a PDA, a tablet (for example, an APPLE® iPad or iMac®), mp3 player, or electronic reader that comprises a camera or other video capturing, or visual recording, device. Furthermore, the mobile device can include a computer, such as a laptop, netbook, or notebook device. Additionally, the first mobile device can include any device capable of being mobile that comprises at least one camera.

The first camera 12 of the smartphone can include any camera, camcorder, or other visual recording device for taking still photographs, motion pictures, or any combination therein. For example, first camera 12 can include any device that includes an aperture controlled by a shutter. The first camera 12 can be triggered remotely through a process that can be initiated by a user as described in greater detail below.

The mobile device, smartphone, or other multifunctional imaging device 14, preferably includes a first wireless transceiver 16, such as a WiFi and/or Bluetooth®, in addition to a voice/data transceiver used to make phone calls, send and receive texts messages, SMS messages, instant messages, and/or communication by any other means of communication or access through the Internet, internet, intranet, or any other configuration of interconnected devices. The smartphone 14 also preferably includes a first memory 19 with which to store applications, such as an application 18 of the present invention that allows the smartphone's 14 first camera 12 to be remotely triggered, as will be discussed in further detail below.

The system 10 also preferably includes a first remote device 20 to remotely trigger the first camera 12 of the smartphone 14. The first remote device 20 preferably includes a second wireless transceiver 22, such as a WiFi and/or Bluetooth®, to match the first transceiver 16 of the smartphone 14. Alternatively, the first remote device 20 can be replaced with a multifunctional device. The smartphone 14 and the first remote device 20 may establish a first connection 24. More specifically, in preferred embodiments, the connection 24 is preferably wireless, such as by using the first transceiver 16 and second transceiver 22 to allow each of these units to transmit and receive data. These data may be transmitted and received via WiFi, Bluetooth®, or through any other electromagnetic wave or signal capable of wirelessly transmitting and/or receiving data comprising images or video between smartphone 14 and remote device 20. However, in some embodiments, the connection 24 may include a physical connection

The first remote device 20 may also include a second memory 26 to hold data. For example, the first remote device 20 may receive any photos taken by the first camera 12, such as through the first connection 24, automatically, on demand, or on a manually selective basis, and store them in the second memory 26. The first remote device 20 may also share, receive and/or send the data to a computer 28. Thus, the device 20 may also establish a second connection 30 with the computer 28. The computer 28 can include a conventional-type computer such as a laptop or desktop, or it can include other portable devices such as tablets, PDAs, eReaders, cellular phones, mp3 or other audio players, or any other device that includes an input, an output, a processing unit, and a memory. The connection 30 may be wireless, such as by using the second wireless transceiver 22, and/or a physical connection, such as through a universal serial bus (USB) port.

In an exemplary and non-limiting illustrative embodiment, the computer 28 can be used to trigger the first camera 12 of the smartphone 14. In this embodiment, the computer's input device (not shown), such as a keyboard, can be used to remotely trigger the smartphone 14 through the third connection 34. In this example, when a user strikes a key, the computer 28 can transmit a signal through the third connection 34 to instruct the first camera's 12 Application Program Interface (API) to take a picture. The system's 10 operation of the smartphone's 14 API is discussed in greater detail below.

The application 18 can provide a user with several options for selecting, transmitting, sharing, and storing pictures and video taken with smartphone 14. In a first example, a user can establish preferences or a set of rules for managing a user's photos, videos, or both. For example, the user can select to have all photos, videos, or both transmitted to the computer 28, the remote first device 20, or both.

Furthermore, the user can establish preferences so that only a subset of the photos, videos, or both are transmitted automatically to the computer 28, the first remote device 20, or both. For example, the application 18 can employ a geo-tagging feature such that photos or videos taken from a particular location or locations can be automatically transmitted to these other devices. For example, if a user is on vacation at a particular destination, she can establish a custom setting such that all photos taken at that destination are automatically transmitted to another device, thus creating an instantaneous backup of the photos and videos obtained. In other embodiments, the user could manually transmit photos or video obtained from other locations.

In addition to storing and sending preferences, a user can establish preferences for sharing the photos and videos through social media such as Facebook®, Twitter®, etc. For this feature, a user can set preferences so that selected photos and videos are automatically uploaded to one or more social media sites. This can be accomplished based on preexisting tagging and/or indexing features available through the smartphone 14. Additionally, it can be accomplished through an automated or automatic process.

The first remote device 20 preferably includes a button, touchscreen, or other user interface 32. For example, the first remote device 20 can operate through a touch-based command such that the user interface 32 can be activated by a user manually touching the display of the device 20. A user may push the button, touch the display unit of the device 20, or otherwise activate the user interface 32 to induce a communication between the first remote device 20 and the smartphone 14 to trigger the application 18 to cause the first camera 12 to take a photo or video.

The first remote device 20 may also include a battery, or other energy storage system, to power its functionality. The battery may be replaceable and/or rechargeable by the computer 28 or other suitable energy source. For example, the first remote device 20 may include a data interface (not shown), such as male USB port. The data interface may be plugged into a data port, such as a female USB port, on the computer 28, thereby establishing the connection 30, through which the battery of the device may be recharged and the data may be shared. The same, or another, USB port on the first remote device 20 may also connect with a USB port of the smartphone 14 to share energy and/or data between the device 20 and the smartphone 14. For example, the first remote device 20 may be used to recharge the smartphone 14 and/or the smartphone 14 may recharge the first remote device 20. In one embodiment, the first remote device 20 can include more than one remote device.

In any case, as discussed above, upon user activation, the first remote device 20 preferably sends a signal to the smartphone 14 through the first connection 24. The application 18, after having been installed on the smartphone 14, then receives the signal and causes the first camera 12 to take a photo. In this manner, the first remote device 20 may be used as a remote shutter trigger for the first camera 12 of the smartphone 14.

The first remote device 20 can communicate with the smartphone 14 through the smartphone's 14 Application Programming interface (API). To accomplish this, once a user instructs the first remote device to trigger the remote camera 12 of the smartphone 14, a signal can be transmitted to the smartphone 14 so that the first remote device 20 and the smartphone 14 can communicate through the API. This implementation is beneficial because the API allows the first remote device 20 to communicate directly with the firmware and hardware of the smartphone 14. By doing so, the shutter can be triggered almost instantaneously. By capturing the photo or video remotely with little or no delay, the user can safely capture events that transpire in a rapid fashion or succession, thus eliminating a user's concern of missing the opportunity due to undue shutter delay.

The application 18 may be installed on the smartphone 14 after being downloaded. The application 18 may be downloaded from the computer 28 though a third connection 34 which may include a physical connection, such as by using the USB ports, and/or a wireless connection, such as by using the first transceiver 16 and second transceiver 22. In fact, with the computer 28 using the second transceiver 22 of the first remote device 20 to communicate with the first transceiver 16 of the smartphone 14, the third connection 34 may actually consist of the first connection 24, the second connection 30, or both.

Alternatively, and preferably in some embodiments, the application 18 may be is downloaded from an Internet based server, such as the Apple's iTunes Store or the Android Market. For example, the user can download the application 18 through the Internet, internet, intranet, server, or through any other means that is able to transmit or transfer data or information. For example, in an exemplary and non-limiting illustrative embodiment, the end user can load the program by downloading the program from a service such as the APPLE® App Store. In any case, the smartphone 14 may use its first transceiver 16 and/or its voice/data transceiver to download the application 18. The application 18, once downloaded and installed, may control any or all functions of the first camera 12 and may make any or all functions of the first camera 12 controllable through the user interface 32 of the multifunctional device 20. For example, the first remote device 20 may control the video capture or camcorder capabilities, as well as any brightness, contrast, effects, or other settings of the first camera 12, through interaction with the application 18 installed on the smartphone 14.

In any case, the present invention allows the user to remotely capture a photo using the first camera 12, or otherwise fully remotely control the first camera 12, of her smartphone 14. This is especially useful in taking self-portrait and/or group photos, with the user being captured in the photo or video.

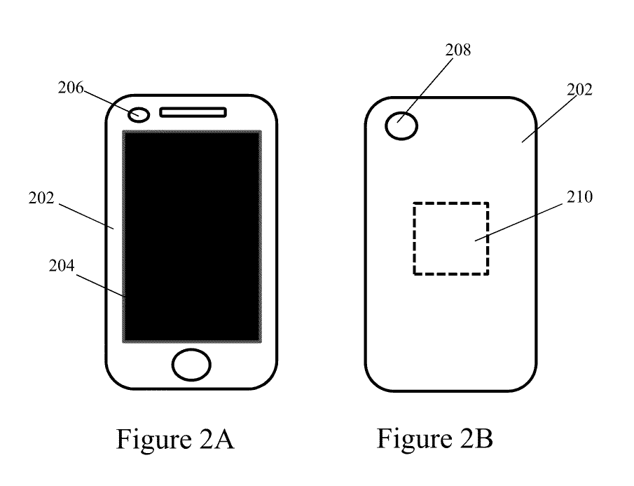

FIG. 2A illustrates a front view of the first embodiment of the mobile device illustrated in FIG. 1. FIG. 2B illustrates a back view of the first embodiment of the mobile device illustrated in FIG. 1. These figures will be described in conjunction with one another.

The mobile device 202 can include a display unit 204, a first mobile device camera 206, a second mobile device camera 208, and a computer readable medium 210. The computer readable medium 210 can further include computer readable instructions. The computer readable instructions can refer to any instructions that can be performed by a computer or processing unit.

The mobile device 202 can include any cellular phone, such as a BlackBerry® device, iPhone®, Android® or any other portable device such as a PDA, a tablet (for example, an APPLE® iPad or iMac®), mp3 player, or electronic reader that comprises a camera or other video capturing device. Furthermore, mobile device 202 can include a computer, such as a laptop, netbook, or notebook device. Additionally, mobile device 202 can include any device capable of being mobile that comprises at least one camera 206 including, but not limited to, all the examples and embodiments described in conjunction with the mobile device/smartphone 14 as illustrated in FIG. 1.

The first mobile device camera 206 and second mobile device camera 208 can include any camera, still and/or motion picture capturing device, or any other visual recording device for capturing, recording, or storing images or videos. In one embodiment, the first mobile device camera 206 can be located on a first side (e.g., the front) of the mobile device 202 and the second mobile device camera 208 can be located on a second side (e.g., the rear) of the second mobile device 202. In other embodiments the first and second mobile device cameras 206, 208 can be located on the same side of the second mobile device 202.

The display unit 204 can include an LCD, LED, CRT, plasma, or any other display format or configuration adapted to be used to display data, images, video, or other information on an electronic device. The computer readable instructions can include executable, non-executable, assembly, machine, compiled, or un-compiled code, or any other instructions that can be read by a computer.

The computer readable medium 210 can refer to any medium that may be used in conjunction with computer readable instructions. In an exemplary and non-limiting illustrative embodiment, the computer readable medium 210 can include a computer readable storage medium. The computer readable storage medium can take many forms, including, but not limited to, non-volatile media and volatile media, floppy disks, flexible disks, hard disks, magnetic tape, other magnetic media, CD-ROMs, DVDs, or any other optical storage medium, punch cards, paper tape, or any other physical medium with patterns of holes. Computer readable storage media can further include RAM, PROM, EPROM, EEPROM, FLASH, combinations thereof (e.g., PROM EPROM), or any other memory chip or cartridge.

The computer readable medium 210 can further include computer readable transmission media. Such transmission media can include coaxial cables, copper wire and fiber optics. Transmission media may also take the form of acoustic or light waves, such as those generated during radio frequency, infrared, wireless, or other media comprising electric, magnetic, or electromagnetic waves.

Other and further embodiments utilizing one or more aspects of the inventions described above can be devised without departing from the spirit of Applicant's invention. Further, the various methods and embodiments of the present invention can be included in combination with each other to produce variations of the disclosed methods and embodiments. Discussion of singular elements can include pluralelements and vice-versa.

For example, in one embodiment (by referring to FIG. 1), the first remote device 20 can actually include a second smartphone (not shown). In this case, the application 18 on the smartphone 14 may communicate with the application 18 on the second smartphones (not shown) to control any or all functions of the camera of the second smartphone (not shown). This embodiment may be especially useful where two or more users wish to be in a photo taken with one of the user's smartphones 14. In fact, this embodiment would not require that either user carry anything other than their smartphones 14; one to actually take the photo and the other to act as the remote shutter trigger or control. In another embodiment the first remote device 20 can include a remote control unit.

The application 18 can further include camera features in addition to those that are provided as a standard package on a smartphone 14. For example, application 18 can allow a user to control the timing, shutter repetition speed, zoom, multi-shot, and photo transmission and storage features. For the multi-shot photo feature, a user can trigger the first remote device 20 once to take several pictures in rapid succession. With this feature, a user can control the number of successive shots (e.g., five photos) to be taken in rapid succession, and the shutter repetition speed between each shot (e.g., 0.5 ms) with a single triggering of the smartphone 14.

For the timing delay, a user can select an option to delay the first camera's 12 shutter operation by a matter of several seconds with respect to the time the user triggers the first remote device 20. This can allow a user to trigger the remote shutter feature on a timing delay to provide the user with sufficient time to prepare for the photograph after triggering the first remote device 20. This feature is especially useful when the system is operating in Camera Mirror Mode, as further described below in conjunction with FIG. 1.

A user can operate the system 10 in Camera Mirror Mode by employing the use of a second remote device (not shown) that can be used in place of the first remote device 20. The second remote device can include any mobile device that includes a display unit and a wireless transceiver, such as a mobile phone, PDA, tablet, eReader, or the like. The second remote device can further include those components disclosed in connection with the first remote device 20 (e.g., a memory, a user interface, etc.) In this mode, the second remote device may receive a live transmission of the environment captured within the range of the first smartphone's 14 first camera 12 via the first connection 24. In other words, the images displayed on the smartphone's 14 display unit can be mirrored on the second device's display unit in real-time while the smartphone 14 is in camera or video mode. While operating in this mode, a user can check the images displayed on the display unit of the second device before remotely triggering the camera on the smartphone 14 in order to make any last minute changes to the environment to be captured by the video or photo, if necessary. These images can be transmitted from the smartphone 14 to the second remote device in real-time via the first connection 24 through a WiFi, Bluetooth, or any other electromagnetic wave or signal capable of wirelessly transmitting and/or receiving data comprising images from a first device to second device.

In additional embodiments, the remote trigger features described above are not limited to a visual recording device, such as a camera or a video recording device (e.g., camcorder). For example, the first remote device 20 can be used to trigger other aspects of the mobile device 14 such as an audio recorder, the mute and volume buttons, etc. In an exemplary and non-limiting illustrative embodiment, the first remote device 20 can be used to control a microphone for voice memos and other preexisting audio features of mobile device 14.

The order of steps can occur in a variety of sequences unless otherwise specifically limited. The various steps described herein can be combined with other steps, interlineated with the stated steps, and/or split into multiple steps. Similarly, elements have been described functionally and can be embodied as separate components or can be combined into components having multiple functions.

The term “coupled,” “coupling,” “coupler,” and like terms are used broadly herein and can include any method or device for securing, binding, bonding, fastening, attaching, joining, inserting therein, forming thereon or therein, or otherwise associating, for example, mechanically, magnetically, electrically, chemically, operably, is directly or indirectly with intermediate elements, one or more pieces of members together and can further include without limitation integrally forming one functional member with another in a unitary fashion. The coupling can occur in any direction, including rotationally.

The term “trigger,” “triggering,” “triggered,” “triggers,” and like terms are used broadly herein and can include any method or device for initiating, precipitating, instantiating, activating, producing, prompting, provoking, causing, or eliciting a visual recording device such as a camera, camcorder, or the like to carry out its function of capturing, recording, or otherwise storing photographs, videos, or other visual media. In an exemplary and non-limiting illustrative embodiment , the term “triggering” can include causing the shutter of a camera to open and close its aperture for receiving light. In another example, the term “triggering” can include the starting and stopping of a video recording process,

The inventions have been described in the context of preferred and other embodiments and not every embodiment of the invention has been described. Obvious modifications and alterations to the described embodiments are available to those of ordinary skill in the art. The disclosed and undisclosed embodiments are not intended to limit or restrict the scope or applicability of the invention conceived of by the Applicants, but rather, in conformity with the patent laws, Applicants intend to fully protect all such modifications and improvements that come within the scope or range of equivalent of the following claims.

What is claimed is:

1. A system for remotely triggering a visual recording device, the system comprising:
a mobile device comprising a camera; and
a multifunctional device comprising a user interface;
wherein the multifunctional device is adapted to remotely trigger the camera through a first connection.

2. The system for remotely triggering a visual recording device according to claim 1, further comprising a computer adapted to receive data comprising images, videos, or both from the multifunctional device through a second connection.

3. The system for remotely triggering a visual recording device according to claim 2, wherein the computer is adapted to receive the data based on a user's preferences stored on the mobile device.

4. The system for remotely triggering a visual recording device according to claim 1, wherein the multifunctional device is adapted to automatically receive images, video, or both from the mobile device based on a user's preferences.

5. The system for remotely triggering a camera of a multifunctional device according to claim 1, wherein the first connection is a wireless connection.

6. The system for remotely triggering a camera of a multifunctional device according to claim 1, wherein the multifunctional device further comprises a computer readable medium adapted to store an application configured to operate the camera.

7. The system for remotely triggering a visual recording device according to claim 6, wherein the application is configured to operate the camera through an Application Programming Interface (API) of the mobile device.

8. A computer readable storage medium configured to store an application on a mobile device for remotely triggering a visual recording device, wherein the application is adapted to execute instructions comprising:
receiving an input from a multifunctional device comprising a user interface; and
remotely triggering a camera coupled to the mobile device based on the input received from the multifunctional device through a first connection.

9. The computer readable storage medium according to claim 8, wherein the application is adapted to execute instructions further comprising transmitting images, videos, or both from the mobile device to the multifunctional device.

10. The computer readable storage medium according to claim 8, further comprising receiving a user's preferences for transmitting images, videos, or both to the multifunctional device automatically.

11. The computer readable storage medium according to claim 8, wherein remotely triggering a camera coupled to the mobile device further comprises operating the camera through an Application Programming Interface (API) of the mobile device.

12. The computer readable storage medium according to claim 8, wherein remotely triggering a camera coupled to the mobile device further comprises remotely triggering a camera through the first connection wirelessly.

13. The computer readable storage medium according to claim 8, wherein receiving an input further comprises receiving an input from a smartphone.

14. A multifunctional device for remotely triggering a visual recording device, the multifunctional device comprising:
a user interface, wherein the user interface is adapted to instantiate a remote triggering of a camera coupled to a mobile device; and
a transceiver, wherein the transceiver is adapted to communicate with the mobile device through a first connection.

15. The multifunctional device for remotely triggering a visual recording device according to claim 14, further comprising a memory adapted to store images, videos, or both received from the mobile device.

16. The multifunctional device for remotely triggering a visual recording device according to claim 14, further comprising a rechargeable power source.

17. The multifunctional device for remotely triggering a visual recording device according to claim 16, further comprising a data interface.

18. The multifunctional device for remotely triggering a visual recording device according to claim 17, wherein the data interface is adapted to couple with a computer to transmit and receive data, receive power to recharge the rechargeable power source, or both.

19. The multifunctional device for remotely triggering a visual recording device according to claim 14, wherein the first connection is a wireless connection.

20. The multifunctional device for remotely triggering a visual recording device according to claim 14, wherein the user interface is further adapted cause an application stored on the mobile device to trigger the camera through an Application Programming Interface (API) of the mobile device.
